(19) United States
(12) Patent Application Publication
(10) Pub. No.: US 2019/0276361 A1
(43) Pub. Date: Sep. 12, 2019

(54) Formulations/Mixtures and improved processes for manufacturing Fire Liner Panels

(71) Applicants: MARC ANDREW WINKELMAN, Chandler, AZ (US); JAMES PAUL JENKINS, Amity, OR (US)

(72) Inventors: MARC ANDREW WINKELMAN, Chandler, AZ (US); JAMES PAUL JENKINS, Amity, OR (US)

(21) Appl. No.: 15/916,987

(22) Filed: Mar. 9, 2018

(51) Int. Cl. C04B 28/04; E04C 2/28; E04B 1/94; E04H 9/00; E04C 5/07; C04B 14/42; C04B 40/00; B28B 1/14; B28B 11/24; B28B 1/52

(52) U.S. Cl. CPC C04B 28/04; E04C 2/28; E04B 1/942; E04H 9/00; E04C 5/073; E04C 2002/004; C04B 40/0089; B28B 1/14; B28B 11/24; B28B 1/52; E04B 2103/02; C04B 14/42

(57) ABSTRACT

The invention is the development of new and unique formulations and mixtures along with unique and improved manufacturing processes for a clear departure for all manufacturing processes in which calcium silicate or cement-based formulations and mixtures are commonly utilized in manufacturing fire liner panel systems of the prior art. The invention serves the current fire protection/training industry with new and unique formulations and mixtures along with improved manufacturing processes that produce a fire liner panels system with enhanced performance characteristics which are unparalleled teachings not present, nor found in any of the prior art.

### CROSS REFERENCE TO RELATED APPLICATIONS

There is no cross reference applicable.

### STATEMENT OF FEDERALLY SPONSORED RESEARCH

There is no federally sponsored research for this invention.

### SEQUENCE LISTING, TABLE, COMPUTER PROGRAM

There is no such Sequence Listing applicable.

### BACKGROUND OF INVENTION

This invention relates specifically to the prior art that is currently utilized in the fire protection and fire training industries to protect fire training building facilities from structural damage that results from the harsh conditions of operating five fire training events in the training of firemen. The fire liner protection service industry is the field of endeavor that the invention pertains. The invention is a total replacement of the current formulations/mixtures and manufacturing processes of the prior art of manufacturing calcium silicate based or cement-based fire liner panel systems.

The invention teaches:
(1) New and unique formulations/mixtures of high temperature resistant cement-based composites.
(2) Unique and improved manufacturing processes.

Current Types of Fire Liner Panel Systems and Their Limitations:

Currently in the fire protection and fire training industries there are three types of non-structural fire liner panel systems available to be specified as a protective fire liner by architects/engineers for builders to line a building's interior, exterior walls, ceilings, beams and column supports of fire training buildings/structures.

These fire liner panel systems are typically manufactured using various base formulations of either 1) calcium silicate, 2) cement bases, or 3) stainless steel.

These various fire liner panel systems of the prior art that are being produced for use in fire training facilities to meet the certification requirements of National Fire Prevention Association (NFPA), have many short-comings that result in short life cycles and overall failures.
1. The calcium silicate or cement-based formulated panels are very porous and will readily absorb water because of the use of sand and aggregate (sand and gravel) in their formulations. In a typical day of a fire training facility multiple cycles and repeated evolutions of training take place wherein the liners are subjected to repeated live fire-burn and water fire suppression evolutions. When the fire liner panels are saturated with water then super heated during the live fire-burn evolution of a fire training drill, to then be rapidly cooled with cold water during the fire suppression phase of the drill, the absorbed water is trapped in the porosity and rapidly expands into stream that cannot easily nor quickly vent out of the porosity of the panels. In this “thermal shock” phase, the expansion of water causes an explosive and damaging force that produces spalling, structural cracking and or the warping/misshaping of the panels. The panels see continued degradation with each training evolution conducted until the panels no longer are “certified” for further use of preservation of neither the structural integrity of the building nor the safety of the firemen, which the fire liner panel systems were designed to protect.

The damage of the liner panels results in the constant increased maintenance and/or added expense for panel replacement due to short lifecycle yields. The calcium silicate or cement-based formulated panels are required to be sealed regularly with a non-flammable silicone coating product in order to prevent water absorption, although panels still absorb water and are damaged through thermal shock and continue to need replacing. The attempt to seal the panels are futile as the sealer is applied after the panels are installed and only the face of the panels receive treatment, which leaves all the back's and sides of the panels free to absorb water.
2. The calcium silicate or cement-based formulated panels lack durability and strength for use in the application requirements of a long term cost effective fire liner panel systems. This is primarily due to the formulation selection of the compounds/elements/ingredients, which include sand and gravel, that are used to produce the panels, coupled with the process that the panels are manufactured. The formulations create heightened porosity and weak comprehensive, flexural and tensile strengths when compared to the invention. The harsh live-fire burns followed by cold water suppression environments along with the impact of the firemen and their equipment, high pressure water suppression activities are brutal on the life expectancy of these systems. This is the direct cause of these systems showing signs of failure in as little as one to two years of being installed and warranting replacement soon thereafter. The panels systems of the prior art are not currently nor have they ever been structurally reinforced with steel of the prior art of steel reinforced cements nor the fiber and textile reinforcements of the invention. The panels of the invention are manufactured with the fiber and textile reinforcements, which ultimately enhance the performance characteristic yields of the fire liner panels of the invention. Due to the fact that the calcium silicate or cement-based formulated type panels are not reinforced with fiber or textiles for structural integrity, they can sustain localized failure which can result in a catastrophic domino type sequence of panel failures leading to an overall failure.
3. The calcium silicate based formulated panels require the installation of insulation blankets or rolled batten materials to be placed as the primary heat and flame impingement underlayment protection between the liner system and the buildings structure as per manufacturers mandated installation procedure. The calcium silicate based formulated panels are installed as a “just ok” soft “drywall like material” only viewed as a consumable/replaceable liner system, which wears better than the true/real, longer term heat and flame impingement protection provided by the insulation blankets or rolled batten protection layer.
4. The cement-based formulated panels also require the installation of secondary calcium silicate panels to be place as a heat and flame impingement underlayment protection as per manufacturers mandated installation procedure. In the section above it was already noted that calcium silicate isn't a good heat and flame impingement protection material, it then becomes clear that the cement-based panel system is relying on the hope that two poor layers of protection will be enough to protect the structural integrity of the building. The cement-based formulated panels have increase wear durability over the calcium silicate panels, but have much higher porosity creating higher absorption characteristics resulting in reduced thermal shock resistance thus suffering increased damages to the panels. The cement-based panels have little heat/thermal resistance rely entirely on the calcium silicate panels for heat and flame impingement resistance/protection. As long as they are covered and protected against the direct impact of the abuses of the firemen, their equipment and the direct heat and flame impingement the calcium silicate panels will hold up well. The invention does teach the need for a two layer system to provide protection of the structure being lined.
5. The calcium silicate or cement-based formulated panels are attached to a system of metal hat channels using a technique of leaving the panel mounting screws loose. This allows for the compensation of high levels of expansion and contraction movements of the panels during rapid heating and cooling (i.e., thermal shock), which means assured damage to the panels and increased periodic maintenance or adjustments will be required. Manufacturers recommend installation gaps between installed panels being anywhere from ¼ of an inch up to as much as ½ of an inch. These loose fitted panel systems with gap are not ideal in totally protecting against heat and flame impingement liabilities, which puts the buildings structural integrity at risk.

In contrast the invention teaches a “no gap” requirement between the panels, as the expansion and contraction differential of the invention doesn't exist to any measurable concern. This is due primarily to the formulation and selection of the compounds/elements/ingredients that are used to manufacture the panels.
6. The various manufacturers of the calcium silicate and cement-based formulated panel systems warn against the use of these systems in freezing temperatures and or extreme cold climate installations, due to the increased temperature differential of the “thermal shock”, i.e. explosive spalling, cracking and or the warping/misshaping of the panels, especially if they are saturated with trapped water in the porosity then rapidly heated in freezing conditions. The expansion and contraction differential between a frozen panel which is then super heated then rapidly cooled again presents the harshest thermal shock stresses which will result in damaged liner panels.
7. All manufactured liner panel systems offered to the fire protection/training industry have a “one size fits all” panel design. The installers of the panels must modify the panels at the installation site to line the various lengths, widths, height profiles of the walls/ceilings of the building. The invention teaches the practice of custom casting to produce exacting sized fitting panel to eliminate labor and material waste. The invention provides a manufactured casting in plurality of specific designed panel profile shapes and sizes which creates unparalleled efficiencies of cost savings for both material and labor required to complete installations.
8. Stainless steel fire liner panels are another option for a fire liner panel system. Stainless steel fire liner panels have short comings as per the following:
   a) The stainless steel type panels require additional insulating materials such as insulation blankets, rolled batten materials and or insulating calcium silicate panels to be place as a heat and flame impingement underlayment protection as per manufacturers mandated installation procedure. The stainless steel pan& systems having zero heat/thermal resistance relies entirely on the insulation materials for heat and flame impingement resistance/protection. Again the liner system (stainless steel panels) are being used as a consumable/replaceable and short lived liner system, which wears better than the true/real and longer term heat and flame impingement protection provided by the insulation underlayment.
   b) The stainless steel type panels greatly expand and contract when heated/cooled. This causes buckling, warping/misshaping of the panels and/or cracking of the panels leading to early replacement.

The invention eliminates these referenced problems and is a significantly stronger and a longer lasting structural fire liner panel system, due to the invention's new and unique formulations/mixtures and improved manufacturing processes.

The cement-based formulations/mixtures of the prior art all utilize sand and aggregate which have defined as the source of porosity and weakness. That sand and gravel are integrated with a cement paste (Portland cement) as a binding agent/element, which is the foundational ingredient, compound and or element of the cement-based formulations/mixtures, thus these formulations/mixtures are classified as cementitious mixtures.

The use of cement paste (Portland cement) as the binding agent/element of the formulations/mixtures in both the prior art and the invention are desirable, preferred, stable and is an unequalled binding agent in terms of being economical, widely available and durable for centuries. This cement paste/binding agent is by itself has a very dense, low/negligible porosity and does not dissolve, emulsify or transform from one state to another once the process of hydration sets the paste into a hardened crystallized state. In other words it is very stable unlike the sand, gravel and steel reinforcements of the prior art. The invention teaches that the cement paste be highly augmented with fly ash to radically improve performance characteristics and increased fire/heat resistance of the base paste/binder.

It is widely thought that cement-based formulations/mixtures of the prior art are typically only reinforced with steel when in fact the cement paste/binder is the base composite/matrix and it is reinforced with two reinforcements; 1—Aggregates (sand and gravel) 2—Steel (rebar). The aggregate (sand and gravel) are a localized form of reinforcements in that they are individual/separate small building blocks, which can suffer localized structural failure that in turn can lead into overall catastrophic structural failure. Although the content of sand and gravel are densely, thoroughly and uniformly present throughout the entirety of every single cubic inch of a cement-based formation they lack an interlocking/linked structural integrity of continuity. The cement paste, sand and gravel produce great comprehensive strengths but lack any tensile strengths. In contrast the steel reinforcement represents a very sparse density of the total volume in a cement-based formation. The steel produces the interlocking/linked structural integrity of continuity (tensile strength) that the sand and gravel reinforcements are incapable of delivering. At the end of the day the cement paste/binder of the prior art are typically reinforced by three reinforcements i.e. sand, gravel and steel.

To articulate how sand and gravel perform as reinforcement of the cement paste/binder of cement-based formulations/mixtures of the prior art, the analogy of a block wall being viewed as a microscopic image of cement-based formulations/mixtures will articulate the concept. The blocks of the wall represent the aggregate and the mortar between the blocks represents the cement paste. Structurally speaking one would never want to see a block wall where the mortar joints between the block were three inches thick, as this would produce a very weak block wall. The mortar is not a strong enough material to be used in thickness over ¾ of an inch. Speaking from the logistics of the application of building a block wall; one would never want to lay a course blocks on three inch bed of mortar as just after the mason completes placing the block exactly to the level of the set string line, moments later the block would sink to an undesired level even if using a very low slump (dry) mortar. Even when laying block on a ½ inch bed of mortar you can experience the level of a block dropping, that is why procedurally you find a mason laying one course horizontally for as far as the run of the course will go before laying another course on top of a lower course that was just laid, in fear of the next correctly laid block would start to sink or drop down below the prior set string level. With that said, the cement paste/binder needs to be properly reinforced with aggregate (sand and gravel) uniformly to achieve the proper density proportion ratio of the cement paste to aggregate reinforcements.

It should be noted that NONE of the calcium silicate or cement-based fire liner panel systems of the prior art utilize any steel reinforcement at all. The prior art only teaches the use of localized reinforcements of aggregates (sand and gravel). The prior art does not teach the use any kinds or types of interlocking/linked structural integrity of continuity such as steel reinforcements. This is due to the size/dimensions of the fire liner panels that are currently being utilized in the fire protection/training industry. The fire liner panels of the prior art are typically 12 inches (L) by 12 inches (W) by 1½ inches (D) i.e. one square foot. The largest cement-based panel of the prior art is 16 inches (L) by 16 inches (W) by 1½ inches (D) i.e. 1.77 square feet. The prior art teaches that due to the small structural span of these panels that interlocking/linked structural continuous reinforcements are not required. The prior art teaches that the formulations/mixtures provide enough structural strengths in and by themselves.

The invention teaches the use of interlocking/linked structural continuous reinforcements with the use of a minimum of two separate layers of a glass reinforced woven mesh be place in every casted panel and high density placement of glass fiber, which results in dramatically stronger performance characteristics in the fire liner panels of the invention. Therefore this invention is capable of larger panel sizes than what the industry produces.

Reinforcement drawbacks of prior art: The major drawbacks that result from the current cement-based formulations/mixtures embodied by the prior art are as follows:

The reinforcements taught in the prior art in formulating cement-based formulations/mixtures and historically over the last 160+ years are steel and aggregate i.e. sand and gravel. This has been the common practice primarily due to the wide availability of quarried limestone and iron ore. It is a widely held zombie like belief and practice that cements must be made with sand, gravel and rebar wherein it is an unchallenged basis to any and all formulation of cementitious mixtures. The use of limestone and iron type reinforcements in cement-based mixtures are not ideal, but convenient and when thorough performance analysis are conducted it would seem logical that the analyst would recommend replacement materials be explored. The exacting causes of failure are scientifically well known and documented, but the ability to develop innovative solutions are prevented by the mechanics of tradition and standard issue; “Cement-based mixtures are always made with sand, gravel and rebar”. “The world is flat” is somewhat of a comparable oblivious concept of the thought process utilized currently. No industry alternatives have been sought in the replacement of sand and gravel reinforcements in cement-based formulations/mixtures as it is such an unconceivable thought that they could be replaced. All augmentations to the various cement-based formulations/mixtures for sake of addressing these known problems see the formulators keeping the traditional baseline of the formulations/mixtures inclusive of cement paste, sand and gravel to which they add fiber or some type of an admixture seeking to change the characteristic of the formulations/mixtures. Ultimately this methodology does not realize the necessity of radically seeking the replacement reinforcements of the prior art to obtain success.

The invention teaches a radical replacement of the reinforcements of the prior art being achieved. The composition of sand and gravel are largely the same and are only different in size, sand is just smaller gravel. Geologically sand and gravel are predominantly limestone (80%) with granite, gabbro and basalt (20%). The sand and gravel vary considerably in the structure of their composition from one grain of sand to another to one piece of gravel to another. Sand and gravel are very porous in and by themselves and are the primary source the porosity of cement-based formulations/mixtures on the whole. In different cementitious mixtures, the larger the size of the aggregate the more porosity will be found. In mixtures such as a thin paint on type of application of “water stop” (hydraulic cement) no aggregates are used at all, this gives the mixture less porosity and a sealer like property. Some brands of “water stop” are formulated with small amounts of fine sand, which creates an increased level of porosity over the former. The thinner a mixture is applied the less amount and the finer the sand will be. Water stop type cement mixtures cannot be used to pour a 6″ inch thick concrete driveway, as the mixture hasn't the larger aggregate structure and would be brittle and crumble. Concrete mixtures cannot be used to plaster a swimming pool as the aggregates are too large and course to be applied is such a thin application and is far to porous to effectively seal a concrete pool. With that said all cement-based formulations/mixtures are very porous and unstable due to sand and gravel being used as reinforcements. The porous cement-based formulations/mixtures of the prior art allows moisture (vapor and liquid) in combination atmospheric gases produce acidic moisture, which intrudes/infiltrates the porous nature of concrete and results in dissolution of the limestone, causing increasing levels of salt movement within the cement-based formation, which furthers the degradation of the aggregate (sand and gravel) and steel reinforcements and decreased longevity of the fire liner panels of the prior art.

The invention teaches the total replacement of all of the reinforcements i.e. aggregate (sand and gravel) and steel of the prior art. The cement paste (Portland cement) being utilized as a binding agent in the prior art is the only compound/element of the prior art being advanced forward into the different formulations/mixtures of the invention. However, the invention teaches the augmentation of the cement paste/binder with exceptionally high levels of fly ash not even considered in the prior art.

Across the entire cement-based formulations/mixtures of the building industry as a whole the use of fly ash is quite prevalent. The average content of fly ash utilized in cement-based formulations/mixtures of the current art is taught to be 7% of the total content of cement; ultimately the fly ash is never to exceed 15% of the total content of cement. The current cement-based building industry formulators are very knowledgeably experienced that if fly ash exceeds 7% to 15% of the total content of cement that the strength of the formulations/mixtures would be weakened to the point of becoming structurally un-useable.

The invention teaches the augmentation of the cement content with a minimum content of fly ash to be 40% up to the maximum content of 60% of the total content of cement. This is not a formulation practice that would be condoned by any of the current cement-based building industry's knowledgeable and experienced formulators. The teaching of the invention fully agrees that the inclusion of such high levels of fly ash in the typical cement-based formulations/mixtures of the current art of the entire building industry would be true and correct and would result in failure. The invention teaches the successful and desirable results radical replacement of the standard reinforcements of the prior art with glass fiber and glass reinforced woven mesh, which successfully grain high strengths even in such high leveled fly ash formulations/mixtures.

### BRIEF SUMMARY OF INVENTION

The primary objective of this invention is to provide the fire protection/training industry with a new and unparalleled interlocking fire liner panel system with increased performance characteristics of comprehensive, tensile and flexural strengths, reduction of porosity, increased durability, longevity along with increased heat resistance and possessing greater thermal insulation properties. This objective is achieved through the deployment of new and unique high temperature resistant cement-based formulations/mixtures taught by the invention.
Absolutely no sand, gravel (limestone) or steel reinforcements are formulated, as the invention teaches the total replacement of all of the reinforcements i.e. aggregates (sand and gravel) and steel of the prior art of cement-based formulations and mixtures used to manufacture fire liner panels systems.
Absolutely no sand (limestone) or diatomaceous earth (clay) of the prior art of calcium silicate based formulations and mixtures are taught to be used to manufacture fire liner panels systems of the invention.
Glass fiber and textile (glass reinforced woven mesh) reinforcements are exclusively and strategically utilized for the total elimination of the structural failures that stem from the use of the sand, gravel and steel reinforcements of the prior art, whereby the structural stability of future fire liner panels will be achieved by using the replacement reinforcements taught by the invention.
The cement base of the prior arts composition is 100% Portland cement, to which the reinforcements of sand, gravel and or steel is then added. The invention teaches an augmenting of the 100% Portland cement paste/binder of the prior arts formulations/mixtures with 40% to 60% of fly ash of the total content of cement, which results in improved performance characteristics and increased thermal resistance characteristics that successfully withstand the harsh effects of thermal shock stresses.

Another objective of this invention is to provide an interlocking fire liner panel system with increased performance characteristics of comprehensive, tensile and flexural strengths, reduction of porosity, increased durability, longevity along with increased heat resistance and possessing greater thermal insulation properties. This objective is achieved through the deployment of unique and improved manufacturing processes taught by the invention.
The invention teaches that manufacturing the fire liner panels at dramatically higher temperatures both initially and throughout all the phases of the manufacturing process realizes a radically improved performance characteristics and increased fire/heat resistance over the result taught by the prior art.
The invention teaches that manufacturing the fire liner panels utilizing custom casting processes results in substantial material and installation labor cost savings over the manufacturing processes that taught by the prior art. The fire liner panel systems of the prior art teaches the “one size panel fits all” design, which requires the installer to modify the panels onsite to fabricate total and complete lining coverage of all surfaces to be protected. The prior art further teaches that when casting a panel from a mold the fabricator would fill the complete mold thus always creating a standard dimensional casting. It is always the case that the dimensions of the standard panels of the prior art will not perfectly fit the dimensions of the surface area that is being lined, which requires panels needing to be cut or re-sized to provide exacting and proper fitting coverage. This results in unnecessary expenditure of labor and material waste.
The invention teaches an evaluation of the layout of full size panels needed to line a certain surface area to be lined and deducing what dimension the remaining panels would need to be re-sized to for a perfect fitting. The invention then further teaches a utilization of a custom cast manufacturing process for producing the exacting sizes of the panels required to produce a (no cut-no waste) labor and material cost saving procedure.

It should be noted that NO current fire liner panel systems of the prior art offers this unique manufacturing process in service to the fire protection/training industry. The invention is the only fire liner panel system that provides the unparalleled and unique manufacturing process in service to the industry.

Yet another objective of this invention is to provide increased cost efficiencies through optimized performance characteristics, which provide long term life cycles for the fire liner panels of the invention.

Still another objective of this invention is to provide increased protection of both the fire training facilities/buildings and the firemen whom are trained therein.

Other practical uses and adaptations of this invention should be apparent to those skilled in the art.

### BRIEF DESCRIPTION OF THE DRAWINGS

FIG. 1 is a drawing of a perspective view of the base ingredients of the formulations and mixtures of the invention.

FIG. 2 is a drawing of a side view of a casting of the formulations and mixtures of the invention.

FIG. 3 is a photo of glass fiber.

FIG. 4 is a photo of glass reinforced woven.

FIG. 5 is a photo of the blended cement and fly ash mixture.

FIG. 6 is a drawing of a side view of a typical mold of the prior art

FIG. 7 is a drawing of a side view of an improved mold of the invention.

### DETAILED DESCRIPTION OF THE INVENTION

New and Unique High Temperature Resistant Cement-Based Formulations/Mixtures of the Invention

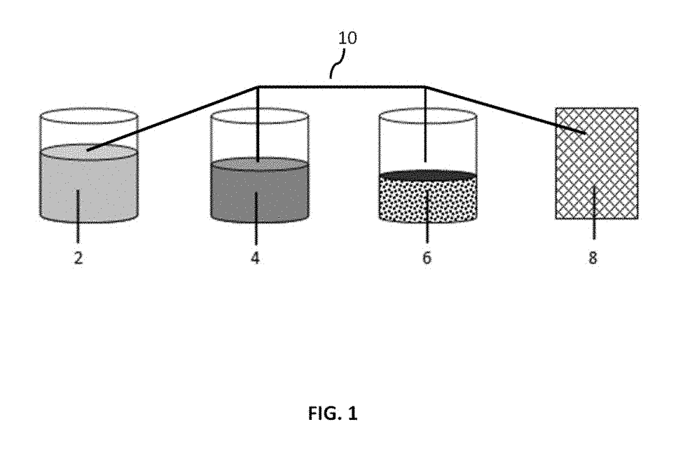

The invention teaches four ingredients are needed for the formulations/mixtures for manufacturing the fire liner panels: FIG. 1 is a drawing of a perspective view of the four base ingredients of the formulations and mixtures of the invention.
2—Fly Ash
4—Portland Cement
6—Glass Fiber
8—Glass Reinforced Woven Mesh

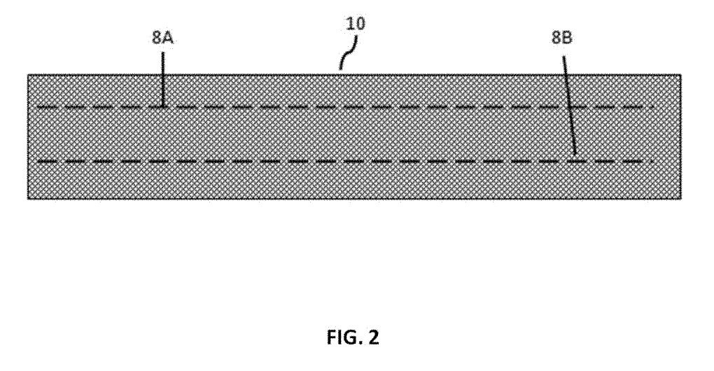

FIG. 2 is a drawing of a side view of a casting of the formulations and mixtures of the invention. The fly ash 2, Portland cement 4 and glass fiber 6 are mixed together 10 and are reinforced with two layers of the glass reinforced woven mesh 8A/8B as a panel is casted.

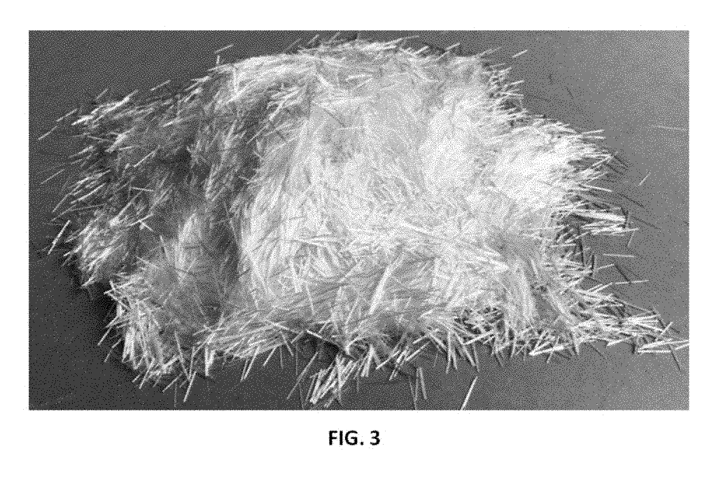

FIG. 3 is a photo of glass fiber.

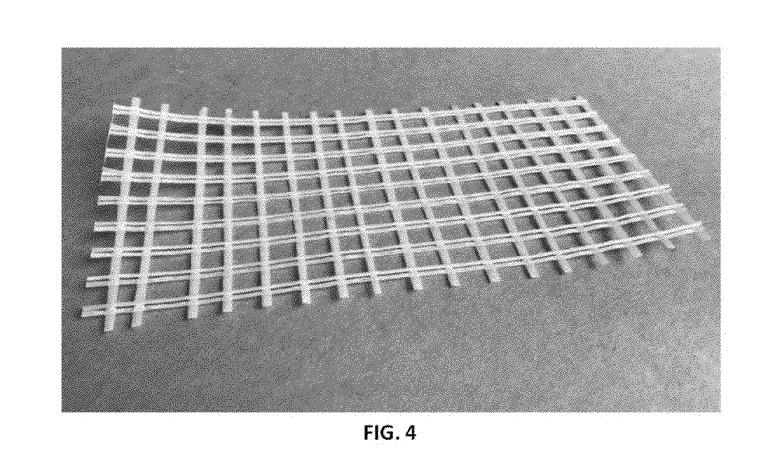

FIG. 4 is a photo of glass reinforced woven.

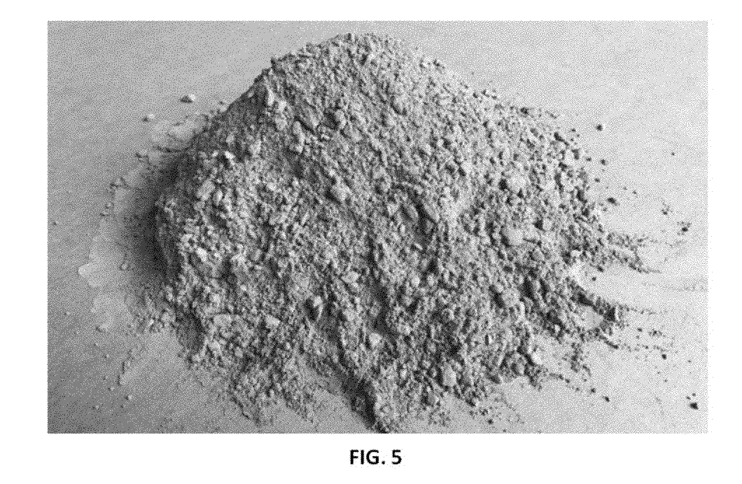

FIG. 5 is a photo of the blended cement and fly ash mixture.

Cement/ash Paste/binding agent: The use of Portland Cement/Fly Ash paste as the binding agent/element of the formulations/mixtures in the invention is desirable, preferred, stable and is an unequalled binding agent in terms of being economical, widely available and durable for centuries. This cement/ash paste/binding agent is by itself has a very dense, low/negligible porosity and does not dissolve, emulsify or transform from one state to another once the process of hydration sets the paste into a hardened crystallized state. The invention teaches that the Portland cement be highly augmented with fly ash to radically improve performance characteristics and increased fire/heat resistance of the base paste/binder.

Fly Ash—The fly ash used in the formulations/mixtures of the invention ultimately provide vast diversity and agility of application uses and allows specific and targeted performance characteristics to be yielded The invention teaches the use of two types of fly ash:
Class F
Class C

There are various types of cements that can be used in the various and different formulations/mixtures of the invention. The different types of cements that can be. The various types of cement to be used are substantiated below, as per ASTM C150:
Type I—High Early Strength
Type II—Moderate specified in said formulations/mixtures ultimately provide vast diversity and agility of application uses and allows specific and targeted performance characteristics to be yielded Sulfate Resistance
Type II (MH)—Moderate Heat of Hydration
Type III—High Early Strength
Type IV—Low Heat Hydration
Type V—High Sulfate Resistance

In addition blended hydraulic type cements to be inclusive as cements for use in formulation/mixtures of the invention, as per ASTM C595:
Type IL—Portland-Limestone Cement
Type IS—Portland-Slag Cement
Type IP—Portland-Pozzonlan Cement
Type IT—Ternary Blended Cement

The blend ratios for the Portland cement to the fly ash can be adjusted to meet specific and targeted performance characteristics. See the cement/ash batching weight ratios below:

| | | |
|---|---|---|
| Portland Cement | Fly Ash | Ratio % |

| | | | | |
|---|---|---|---|---|
| 75 | lbs | 50 | lbs | 60/40 |
| 68.75 | lbs | 56.25 | lbs | 55/45 |
| 62.5 | lbs | 62.5 | lbs | 50/50 |
| 56.25 | lbs | 68.75 | lbs | 45/55 |
| 50 | lbs | 75 | lbs | 40/60 |

Glass Fiber Reinforcement—Glass is utilized as much improved aggregate. There are different available types and sizes of glass fiber. The invention teaches a variety of blended fiber ratios which can be adjusted to meet specific and targeted performance characteristics. The amount of fiber needed for a batch of cement/ash from above—see the fiber batch weights below:

| % of Type-A | % of Type-B | % of Type-C | Total-Lbs | |
|---|---|---|---|---|
| 20% | 30% | 50% | 7 | Lbs |
| 21% | 35% | 44% | 8 | Lbs |
| 22% | 37% | 40% | 9 | Lbs |
| 25% | 40% | 35% | 10 | Lbs |

Glass Reinforced Woven Mesh—The invention teaches the utilization of glass reinforced woven mesh to further reinforce the formulations/mixtures for manufacturing the fire liner panels of the invention. The invention teaches the placement of two layers of the glass reinforced woven mesh in each fire liner panel casting. There are two main reasons for two layers of the mesh:
1. Each of the panels of the invention are 1.77 square feet with the span between the structural channels that the panels are mounted on is no more that 12 inches apart.
2. The panels of the invention are cast at one inch thickness.

With the installation criteria being as described as above two layers of the glass reinforced woven mesh is more than sufficient structural reinforcement to meet any and all structural requirement of the NFPA building code requirements. If larger sized panels and or panels that can serve longer spans the invention provides for modifications to formulations/mixtures with more fiber and mesh reinforcements along with allowances for increased panel profile designs.

The invention teaches adjustable formulations in batching the four ingredients for casting fire liner panels to provide agility in performance characteristic yields. The key to the successes of the invention is there's absolutely NO use of sand, gravel or steel reinforcements taught by the invention. Instead the invention exclusively teaches the use of fly ash, glass fiber and glass reinforcement woven mesh.

Unique and Improved Manufacturing Processes Taught by the Invention

The invention uniquely teaches the observation and practice of controlling ambient temperature ranges of between 70° F.-90° F. prior to casting, during casting, and post temperatures during curing of the formulations/mixtures as an intangible conditioning of the unique and improved manufacturing processes of the invention.

The invention teaches the elements/compounds/ingredients of the invention formulas are stored to the same temperatures. The molds used in the castings are stored and used in the same temperature ranges.

The invention further teaches the utilization of insulated vacuum molds which provide efficiencies and effectiveness in the retention of the high temperature releases generated by the inventions formulations and mixtures in the curing phases. In the curing phase where both the chemical reaction of the cement/pozzolans/water and from the heat that is caused mechanically by the friction of water molecules that hydration produce.

The initial hot water temperatures of 105° F. coupled with the increased temperatures generated during curing along with the retention of these temperatures act like a catalyst for high temperature accelerant in the curing of the castings. The invention teaches a methodology of a free high heat baking process with zero energy costs.

The invention teaches a moisture process with the deployment of the “anti-hydration membrane” which produces a beneficial effect of retaining the moisture of the water molecules that normally leave the mold/casting in the hydration/curing phase of the prior art. The invention teaches an improved and more ideal curing condition in that the formulations/mixtures cure faster and harder due to the retention of increased moist environment over the drier environments taught in the prior art.

These practices are proven to lead to castings with earlier and higher strengths, and the enhanced performance characteristics of comprehensive, flexural (tensile bending), shear, torsion and durability with less porosity, when compared to castings that were produced using cold water or un-improved molds.

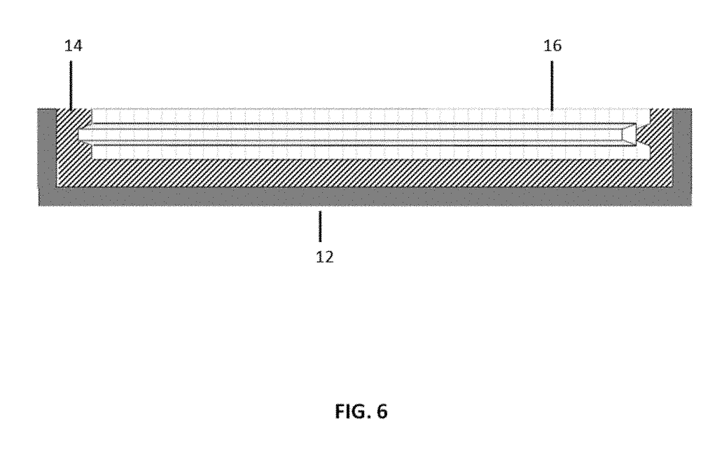

FIG. 6 is a side view of a typical mold of the prior art, which consist of just two elements the hard mold 12 and rubber mold 14 that produces the casting 16. The prior art doesn't teaches the three improvements of the invention. (1)—The use of insulated mold with insulated top. (2)—The use of anti-hydration membrane. (3)—The use of vacuum molding technologies.

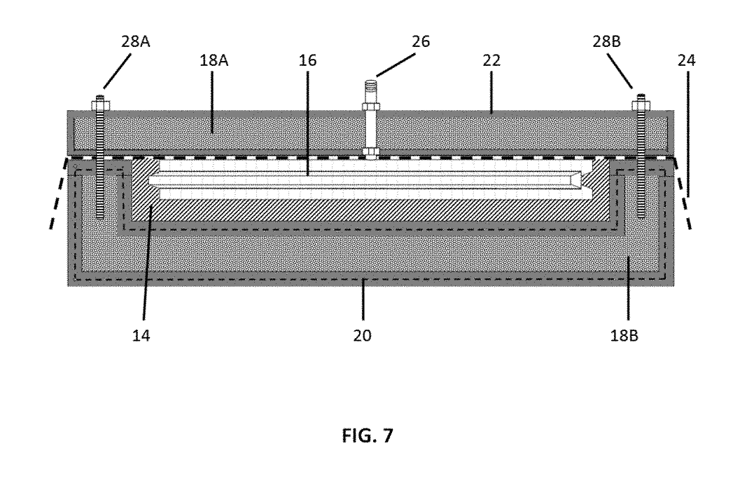

FIG. 7 is a side view of an improved mold of the invention. The improvements taught by the invention are first the insulated 18B hard mold 20, which holds the rubber mold 14 and provide the profile imaging tooling to produce the casting 16. The next improvement is the utilization of the anti-hydration rubber membrane 24, which performs two actions (a) It retains the moisture that normally escapes from the casting/mold during the cure phase. (b) It acts as a gasket between the insulated 18B hard mold 20 and the insulated 18A top 22. The anti-hydration rubber membrane 24 is laid down over the casting 16 once it is completed being casted. The insulated 18A top 22 is bolted 28A/28B down on the insulated 18B hard mold 20 then a vacuum is attached to the vacuum valve 26 and the vacuum is applied to the mold and left to cure over night.

We claim:

1. A variety of new and unique formulations and mixtures of the invention developed to be enhanced formulations and mixtures as radical replacement for all manufacturing processes in which calcium silicate or cement-based formulations and mixtures that are utilized in the manufacturing of fire liner panel systems of the prior art.

2. The new and unique formulations and mixtures as defined in claim 1 wherein said formulations and mixtures of the invention DO NOT utilize any sand, gravel or steel reinforcement of the prior art as ingredients in formulating the new and unique formulations and mixtures of the invention.

3. The new and unique formulations and mixtures as defined in claim 1 wherein said formulations and mixtures of the invention are augmented with unusually high levels of fly ash, which are teachings not present, nor found in any of the prior art.

4. The new and unique formulations and mixtures as defined in claim 1 wherein said formulations and mixtures of the invention are taught to be exclusively reinforced with glass fiber and glass reinforced woven mesh, which are teachings not present, nor found in any of the prior art.

5. Unique and improved manufacturing processes of the invention developed to be enhanced replacement for all manufacturing processes in which calcium silicate or cement-based formulations and mixtures that are utilized in the manufacturing of fire liner panel systems of the prior art, which are teachings not present, nor found in any of the prior art.

6. The unique and improved manufacturing processes as defined in claim 5 wherein said manufacturing processes of the invention teaches utilizing high temperature water to manufacture the new and unique formulations/mixtures, which are teachings not present, nor found in any of the prior art.

7. The unique and improved manufacturing processes as defined in claim 5 wherein said manufacturing processes of the invention teaches utilizing insulated vacuum molds to retain the high temperature releases generated in the curing process, which are teachings not present, nor found in any of the prior art.

8. The unique and improved manufacturing processes as defined in claim 5 wherein said manufacturing processes of the invention teaches utilizing a custom casting process, which saves on labor and material cost and is not offered by any of the fire liner panel system of the prior art.

9. The unique and improved manufacturing processes as defined in claim 5 wherein said manufacturing processes of the invention teaches utilizing manufacturing process that have created and incorporated a high-temperature casting method which yields increased structural strengths for the fire liner panel that exceeds standard industry practices taught by the prior art and the generation of the high temperature requires no cost for the energy to produce the heat needed for the high temperature effect.
